(19) United States
(12) Patent Application Publication
(10) Pub. No.: US 2009/0031594 A1
(43) Pub. Date: Feb. 5, 2009

(54) OBJECT IDENTIFYING ARRANGEMENT AND METHOD OF USING SAME

(76) Inventor: BARBARA WALLACE KOSMIN, Bell Canyon, CA (US)

Correspondence Address: JERRY RICHARD POTTS, 3248 VIA RIBERA, ESCONDIDO, CA, 92029, US

(21) Appl. No.: 12/025,032

(22) Filed: Feb. 3, 2008

Related U.S. Application Data
(60) Provisional application No. 60/962,483, filed on Jul. 30, 2007.

(51) Int. Cl. G09F 3/08

(52) U.S. Cl. 40/6; 40/640

(57) ABSTRACT

An object identifying arrangement includes a fastener, where the fastener generally includes a first sheet of the fastening material that defines a male fastener and a second sheet of the fastening material folded upon itself forming a pocket dimensioned to receive therein the male fastener that defines a female fastener. The fastener is adapted to be attached to an object in order to facilitate object identification and securing purposes.

### CROSS-REFERENCE TO RELATED APPLICATIONS

This application is a non provisional continuation-in-part utility patent application of provisional application Ser. No. 60/962,483 entitled “Fastener for luggage straps that utilizes a hook and loop material with identification pocket attached,” filed on Jul. 30, 2007.

### STATEMENT REGARDING FEDERALLY SPONSORED RESEARCH OR DEVELOPMENT

Not Applicable

REFERENCE TO A “MICROFICHE APPENDIX”

Not Applicable

### BACKGROUND OF THE INVENTION

The present invention is related to fastening devices and more particularly, is related to an fastening device arrangement for identifying an object.

### SUMMARY OF THE INVENTION

An object identifying arrangement includes a fastener, where the fastener generally includes a first sheet of the fastening material that defines a male fastener and a second sheet of the fastening material folded upon itself forming a pocket dimensioned to receive therein the male fastener that defines a female fastener. The fastener is adapted to be attached to an object in order to facilitate object identification and securing purposes.

### BRIEF DESCRIPTION OF DRAWINGS

FIG. 1 is a pictorial view illustrating object identifier attached to a piece of luggage;

FIG. 2 is a pictorial view illustrating another object identifier attached to a lap top computer;

FIG. 3 is a diagrammatic view of an object identifier which is constructed in accordance with the present invention;

FIG. 4 is a cross-sectional view of the object identifier of FIG. 3 taken substantially along line 4-4;

FIG. 5 is a cross-sectional view of the object identifier of FIG. 3 taken substantially along line 5-5;

FIG. 6 is a cross-sectional view of the object identifier of FIG. 3 taken substantially along line 6-6;

FIG. 7 is a diagrammatic view illustrating the male and female fasteners of FIG. 4 about to be fastened removably together;

FIG. 8 is a diagrammatic view illustrating the male and female fasteners of FIG. 4 fastened removable together; and

FIG. 9 is a diagrammatic sectional view of the object identifier of FIG. 3 illustrating the sliding action of the locking plate relative to the combination fastener and identification tag.

### DETAILED DESCRIPTION

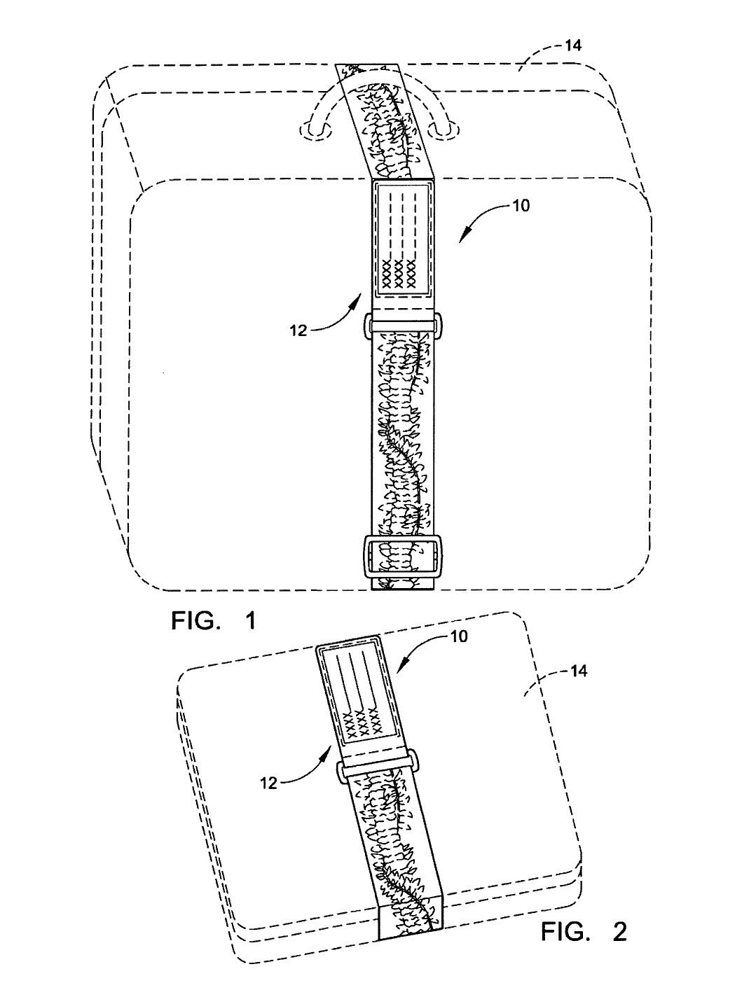

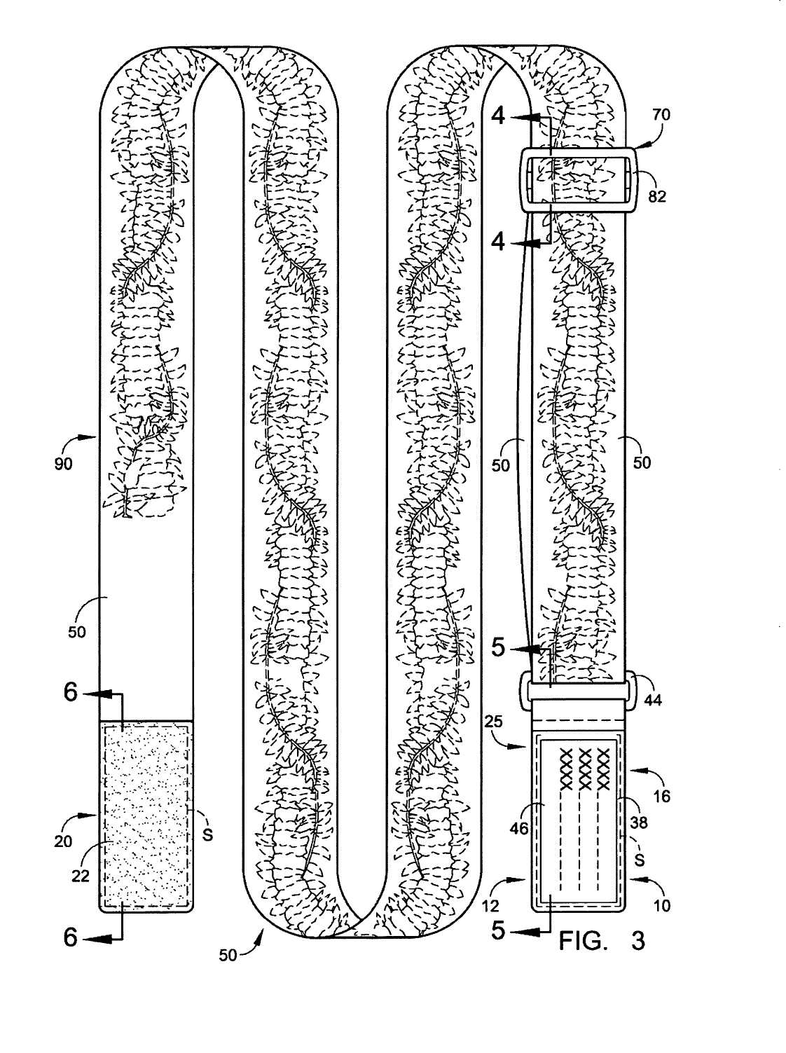

Referring now to the drawings and more particularly to FIGS. 1-3 thereof, there is illustrated an object identifying arrangement 10, which is constructed in accordance with one preferred embodiment of the present invention. The object identifying arrangement 10 utilizes a combination of visual and physical identifiers that can be easily and quickly recognized by a user for identify an object 14, such as a piece of luggage, a brief case, a handbag, a mobile communication device, a lap top computer, sporting goods carriers such as golf bags, duffle bags, and other like hand carried items. The visual identifiers includes at least identification indicia where the identification indicia is selected from a group of identification indicia including color, pattern, text, graphic design, relief design, floral design, lei design, logo design and advertising, where an example of such an identification indicia is generally shown at 90 in FIG. 3. As will be explained hereinafter in greater detail the object identifying arrangement is inexpensive, easily and quickly applied to an object to be identified, and most importantly helping a user to quickly and effectively identify a personal item that may be disposed in a group of items owned by or used by other individuals.

Referring now to the drawings and more particularly to FIG. 3 thereof there is illustrated a diagrammatic depiction of the object identification arrangement 10 which is constructed in accordance with the present invention. The object identification arrangement generally includes at least a fastener identifier 12 which is adapted to have attached thereto a visual identifier 16 that facilitates identification of an object 14 in a fast and convenient manner.

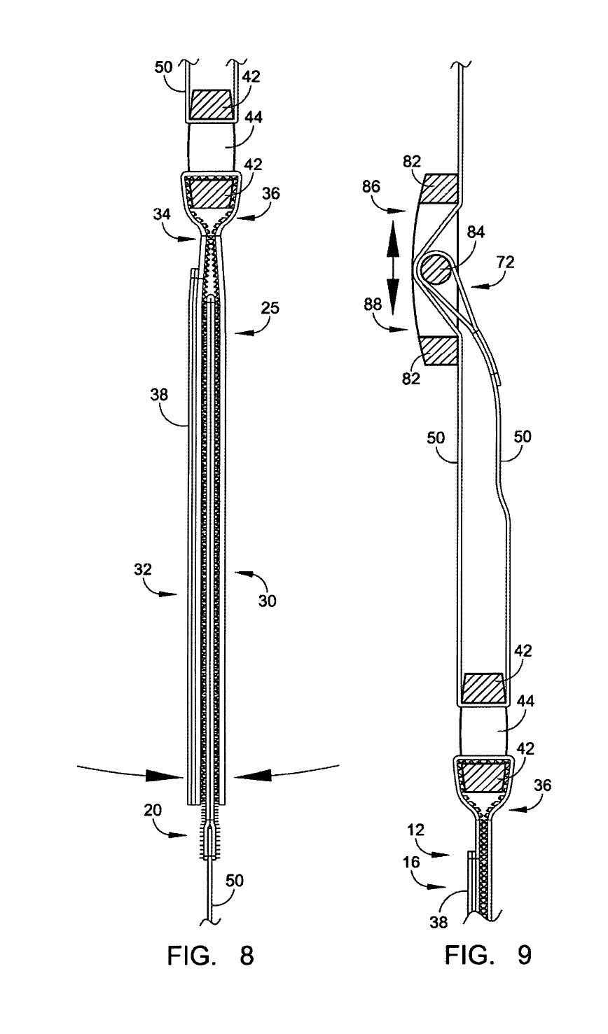

Considering now the fastener identifier 12 in greater detail with reference to FIGS. 3, and 5-8, the fastener identifier 12 generally includes two sheets of fastening material of substantially different length dimensions but having substantially the same width dimensions. The first sheet of fastening material defines a male fastener 20, while the second sheet of fastening material defines a female fastener 25 that will be explained hereinafter in greater detail.

Considering now the first sheet of fastening material 20 in greater detail with reference to FIG. 7, the first sheet of fastening material 20 generally includes a flat sheet a fabric 21 whose upper or top surface area 21U is covered with a plurality of tiny plastic hooks indicated generally at 22 and whose lower or bottom surface area 21B is covered with another plurality of tiny plastic hooks indicated generally at 24. Although in the preferred embodiment of the present invention, the male sheet of fastening material is described as having its upper and lower surfaces covered with a plurality of tiny plastic hooks, it should be understood by those skilled in the art that these surfaces could be covered in the alternative with a plurality of tiny loops for fastening with a plurality of tiny hooks if such an arrangement was more convenient.

Considering now the second sheet of fastening material 25 in greater detail with reference to FIG. 7, the second sheet of fastening material 25 generally includes a flat sheet a fabric 26 which is folded upon itself to form a first leg member indicated generally at 30 and a second leg member 32. The first and second leg members, 30 and 32 respectively come together at about an apex portion generally indicated at 34. The apex portion 34 generally includes a loop 36 which is stitched closed by a stitching material S which allows the loop 36 to be permanently affixed about a continuous leg member 42 of a ring member 44. The ring member 44 in one preferred embodiment of the present invention is an O-ring and in another preferred embodiment of the present invention is a D-ring. It should be understood by those skilled in the art that since the loop 36 is stitched closed about the ring member 44, the first leg member 30 and the second leg member 32 pivot about the continuous leg member 42 to be moved from a legs open position as best seen in FIG. 7 to a legs closed position as best seen in FIG. 5. This is an important feature of the present invention as this feature allows the legs of the female fastener 25 to be opened to receive therebetween the male fastener 20, and to then be closed in a sandwich like arrangement squeezed against the upper and lower surface areas of the male fastener 20 as illustrated in FIG. 5. This creates double fastening areas within the fastener identifier 12 which facilitates its use with a strap identifier 40 that will be described hereinafter in greater detail.

Considering the female fastener 25 in still greater detail, the second sheet of fastening material includes a lower or bottom surface fastening area 26B which is covered with a plurality of tiny plastic loop indicated generally at 27 and an upper or top surface area 26U which is generally a smooth flat surface area 29 free of the tiny plastic hooks and tiny plastic loops mentioned earlier. The upper surface area 26U of the female fastener 25 is a first fastening area which is adapted to have attached or fastened thereto the visual identifier 16 as will be explained in greater detail. The lower surface area 26B on the other hand is a second fastening area which is adapted to be removably fastened to both the upper surface area 21U of the male fastener 20 and the lower surface area 21B of the male fastener 20 in a sandwich like arrangement. As noted earlier, this is an important feature of the present invention as this feature allows the legs of the female fastener 25 to either be spaced from one another about the apex portion 34 (which is secured permanently to the ring member or mounting plate 44) or to be closed against one another for fastening removably therebetween the male fastener 20. Although in the preferred embodiment of the present invention, the female sheet of fastening material 25 is described as having its lower surface covered with a plurality of tiny plastic loops, it should be understood by those skilled in the art that this surface could be covered in the alternative with a plurality of tiny hooks for fastening with a plurality of tiny loops if such an arrangement was more convenient.

In order to enable the fastener 12 to be easily and quickly identified the upper or top surface area 26U the female fastener is provided with identification indicia which is selected from a group of identification indicia that includes: color, pattern, text, graphic design, relief design, floral design, lei design, logos and advertising messages. In addition, to providing the visual identifiers, the object identifying arrangement further includes a clear or transparent sheet of plastic, indicated generally at 38 which is affixed to the upper surface area 26U of the female fastener 25. The plastic sheet 38 is affixed to the female fastener by a stitching material indicated generally at S as best in FIG. 3. The stitching material S is utilized on three sides of the plastic sheet 38 leaving an open end for receiving therein an identification card indicated generally at 46. In one preferred embodiment of the present invention the identification card 46 is a business card and in another preferred embodiment of the present invention the identification care 46 is an identification tag suitable for providing the name of an owner, the address of the owner and the telephone number of the owner. From the foregoing it should be understood by those skilled in the art that the plastic sheet 38 in combination with the female fastener 25 forms a pocket P with a clear or transparent window which is affixed to the lower surface of the female fastener 25.

Although in the preferred embodiment the fastener 12 has been described as having a pocket with a clear or transparent window which is affixed to the lower surface of the female fastener 25, it is contemplated that a paper or fabric like identification card could be directly attached to the female fastener 25 by any convenient attaching means without the need of providing a protective pocket.

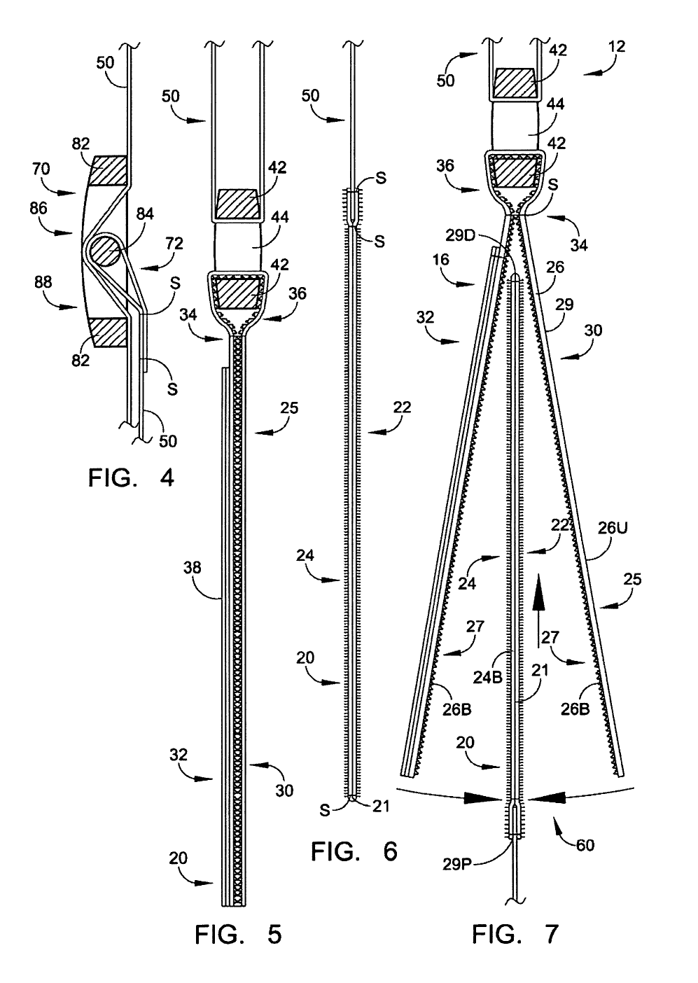

Considering now the male fastener 20 in still greater material with reference to FIGS. 3 and 6, the male fastener 20 has a length dimension which is about one half the length of the female fastener 25. In this regard when the female fastener 25 is folded about in longitudinal length and secured to the ring member 44, the female fastener 25 forms a pocket 60 (FIG. 7) which is adapted to receive therein the male fastener 20. More specifically, a distal end portion 29D of the male fastener 20 is positioned against the apex portion 34 of the female fastener 25 so that it abuts against both of its leg members 30 and 32 respectively. The leg members 30 and 32 may then be closed or pivoted about the apex portion 34 which acts as hinge so that the leg members 30 and 32 engage with and are secured to the male fastener 20. In order to facilitate utilizing the male fastener with the strap identifier 50, one end or a distal end of the strap identifier 50 is attached or affixed to a proximal end portion 29P of the male fastener as best seen in FIGS. 3 and 6. An opposite end or proximal end of the strap identifier 50 is looped around a slide plate or locking plate 70 and is stitched upon itself to form a closed loop 72 which permanently affixes the strap identifier 50 to the locking plate or strap plate support member 70, as best seen in FIG. 4.

Considering now the locking plate 70 in greater detail with reference to FIGS. 3 and 4, the locking plate 70 has a unitary construction which includes a continuous outer ring member 82 with a centrally disposed support leg 84. The support leg 84 divides the continuous outer ring member 82 substantially in half providing the locking plate 70 with a pair of spaced apart apertures 86 and 88 respectively. The apertures 86 and 88 are dimensioned to receive therein in a flat configuration as best seen in FIGS. 3 and 4 the strap identifier 50. This is an important feature of the present invention since this allows the support or locking plate 70 to be slide toward and away from the fastener 12 to cause the length of the loop formed by the identifier strap 50 when it is secured into a loop configuration by the fastener identifier 12. As best seen in FIG. 4, the identifier strap 50 is affixed to the support leg 84 at one of its ends and the other end or the free end of the identifier strap 50 is then passed through the apertures of the locking plate to overlay that portion of the strap identifier 50 which is attached to the support leg 84.

The length of the strap identifier 50 is selected to be sufficiently long to be looped around an object for object identifying purposes. In this case, the length of the strap identifier 50 can be selected to loop around a piece of luggage, a brief case, one or more books, a lap top computer, a mobile communication device and any other like hand carried items. The width of the strap identifier 20 is selected to facilitate easy visual identification of the strap identifier 50 when it is attached to an object, such as a sporting goods activity bag for playing golf or tennis for example.

Considering now the object identifying arrangement 10 in still greater detail, the object identifying arrangement 10 generally include in one preferred embodiment the identifier strap 50 having slidably mounted thereto the mounting plate 44. The mounting plate 44 in turn, has mounted thereto the female fastener 25 wherein the female fastener is a flat sheet of fastening material 27 folded into a V-shape configuration having an apex portion 34 which is attached to the mounting plate 44. The female fastener 25 which includes the free leg members 30 and 32 respectively is adapted to be opened to facilitate receiving therein the male fastener 20 and then when the leg members 30 and 32 are closed it is further adapted to be securing removably to the male fastener 20 in a double fastening arrangement. The male fastener 20 is another flat sheet of material 21, which is attached to one end of the identifier strap 50 to facilitate sandwiching the male fastener between the pair of free leg members 30 and 32 and to further facilitate securing the identifier strap 50 into a closed loop configuration for encircling the object 14 to be visually identified by the identifier strap 50. In short then, the fastener 12 and the identifier strap 50 enable the object 14 to not only be secured or cinched but to also be easily and quickly identified.

In summary then, the object identification arrangement 10 includes a combination of identifiers, including physical identifiers in the form of, for example, the fastener identifier 12, and the strap identifier 50 and visual identifiers in the form of identification indicia that includes colors, patterns, and designs without limitation. In addition, the object identification arrangement 10 may be applied to a plurality of different types and kinds of objects such as for example; luggage, a brief case, sporting goods bags, lap top computers, books, and other hand carry items. The fastener identifier 12 and the strap identifier 50 in combination help secure closed an object. The fastener identifier 12 alone by its unique and novel structure further helps a user immediately identify a personal object based upon, for example, the color of the fastener identifier or the indicia bearing card disposed within the identification pocket. It should also be understood by those skilled in the art that the fastener identifier 12 inclusive of the male fastener 20 and the female fastener 25 by its unique sandwiched sheet structure enables a user to easily and quickly identify an object secured by the fastener 12. Added indicia identifiers further facilitate the ease and speed at which a user can identify a personal object.

It is noted that the preferred embodiments of the present invention described herein in detail for exemplary purposes is of course subject to many different variations in structure, design, application and methodology. Because many varying and different embodiments may be made within the scope of the inventive concept(s) herein taught, and because many modifications may be made in the embodiments herein detailed in accordance with the description requirements of the law, it is to be understood that the details herein are to be interpreted as illustrative and not in a limiting sense.

I claim:

1. An object identifying arrangement, comprising:
an identifier strap;
a mounting plate slidably mounted on said identifier strap and having attached thereto a female fastener;
wherein said female fastener is a flat sheet of fastening material folded into a V-shape configuration having an apex portion attached to said mounting plate and a pair of free leg members which are adapted to be opened to facilitate receiving therein a male fastener and which leg members are further adapted to be closed together to facilitate securing removably said male fastener to each individual one of said pair of free leg members and to still yet further facilitate securing said identifier strap into a closed loop configuration for encircling an object to be visually identified by said identifier strap; and
wherein said male fastener is another flat sheet of material attached to one end of said identifier strap to facilitate sandwiching said male fastener between said pair of free leg members and to further facilitate securing said identifier strap into said closed loop configuration for encircling the object to be visually identified by said identifier strap.

2. The object identifying arrangement according to claim 1, wherein said another flat sheet of material has an upper surface and a lower surface wherein both said upper surface and said lower surface have disposed thereon a plurality of hooks or a plurality of loops to facilitate securing said male fastener between the pair of free leg members of said female fastener.

3. The object identifying arrangement according to claim 2, wherein said flat sheet of fastening material has an upper surface and a lower surface, wherein only said upper surface has disposed thereon a plurality of loops or a plurality of hooks to facilitate securing said female fastener to said upper surface of said male fastener and to said lower surface of said male fastener.

4. The object identifying arrangement according to claim 3, wherein said lower surface of said female fastener has secured thereto an identification card.

5. The object identifying arrangement according to claim 4, wherein said identification card is disposed within a clear plastic pocket affixed to the lower surface of said female fastener.

6. The object identifying arrangement according to claim 5, wherein said identifier strap is provided with identifying indicia to help facilitate visual identification of an object secured by said identifier strap.

7. The object identifying arrangement according to claim 6, wherein said identifying indicia is selected from a group of identifiers including color, pattern, text, graphic design, relief design, and advertising.

8. An object identifying arrangement, comprising:
a fastener including two sheets of fastening material of substantially different length dimensions but having substantially the same width dimensions;
wherein a first sheet of the fastening material defines a male fastener;
wherein a second sheet of the fastening material folded upon itself forms a pocket dimensioned to receive therein said male fastener defines a female fastener; and
wherein said fastener is adapted to be attached to an object for object identification and securing purposes.

9. The object identifying arrangement according to claim 8, wherein said fastener is a fastener identifier adapted to be attached to a visual identifier that facilitates identifying an object; and wherein said first sheet of fastening material has a length and width dimension for defining said male fastener and wherein said second sheet of fastening material has another length and width dimension for defining said female fastener;
wherein said male fastener has an upper fastening area and a lower fastening area and wherein said female fastener has a first fastening area and a second fastening area;
wherein said first fastening area and said second fastening area are spaced from one another about an apex portion affixed to a mounting plate;
wherein said female fastener is configured to enable its first fastening area to engage with and to be secured removably to said upper fastening area of said male fastener; and
wherein said female fastener is further configured to enable its second fastening area to engage with and to be secured removably to said lower fastening area of said male fastener.

10. The object identifying arrangement according to claim 9, wherein said male fastener is adapted to be attached to a visual identifier.

11. The object identifying arrangement according to claim 10, wherein said visual identifier is a transparent sheet of plastic for forming a pocket on said fastener identifier to facilitate receiving within said pocket a card identifier.

12. The object identifying arrangement according to claim 11, wherein said visual identifier is a strap identifier.

13. The object identifying arrangement according to claim 12, wherein said male fastener and said female fastener enable said strap identifier to be formed into a closed loop configuration to facilitate cinching said strap tightly against an object to be visually identified by said strap.

14. The object identifying arrangement according to claim 13, where said strap has a predetermined width dimension and a predetermined length dimension to facilitate easy visual identification of said strap when attached to an object;
said strap having a distal end and a proximal end, wherein said proximal end is attached to a locking plate strap support member and wherein said distal end is attached to said male fastener.

15. The object identifying arrangement according to claim 14, wherein said strap has a sufficient length dimension to be looped around an object for object identifying purposes.

16. The object identifying arrangement according to claim 15, wherein said locking plate has a strap support member and a pair of apertures, wherein the individual ones of said pair of apertures are disposed on opposite sides of said strap support member; and
wherein the proximal end of said strap is permanently attached to said strap support member; and
wherein said strap support member supports from below a portion of said strap to facilitate forming an adjustable strap loop for encircling the object and to further facilitate cinching said strap loop tightly against the object.

17. The object identifying arrangement according to claim 10, wherein said strap has disposed thereon identification indicia; and
wherein the identification indicia is selected from a group of indicia including color, pattern, text, graphic design, relief design, floral design, lei design and advertising; and
wherein said strap is selected with a predetermined length which is sufficient to encircle and be cinched to an object selected from a group of objects including: luggage, brief case, sporting goods, laptop computers, and books.

18. An object identification arrangement, comprising:
a combination fastener and card identifier, wherein said fastener is a female sheet fastener adapted to be opened into a V-shape configuration for receiving there within a male sheet fastener;
wherein said female sheet fastener is further adapted to be closed to sandwich and secure removably said male sheet fastener within said female sheet fastener;
wherein said female sheet fastener and said male sheet fastener each being adapted to be attached to an object identifier.

19. The object identification arrangement according to claim 18, wherein said object identifier is a strap identifier having a distal end and a proximal end, wherein said distal end is affixed to said male sheet fastener and wherein said proximal end is affixed to a locking plate;
wherein said locking plate is slidably mounted on said strap identifier to enable said strap identifier to be configured into an adjustable loop to facilitate encircling an object to be visually identified and secured by said strap; and
a mounting plate having said female sheet fastener affixed thereto, said mounting plate having an aperture for slidably receiving therethrough said strap identifier to facilitate configuring said strap identifier into a closed loop tightly cinched to the object.

20. The object identifying arrangement according to claim 19, wherein said strap identifier includes identification indicia; and
wherein said identification indicia is selected from a group of identification indicia including color, pattern, text, graphic design, relief design, logo, floral design, lei design and advertising;
and wherein said strap identifier is chosen from a group of straps including a luggage strap, a book strap, a sports activity strap, a lap top computer strap and a mobile communication device strap.
